(19) United States
(12) Patent Application Publication
(10) Pub. No.: US 2016/0350981 A1
(43) Pub. Date: Dec. 1, 2016

(54) IMAGE PROCESSING METHOD AND DEVICE

(71) Applicant: SuperD Co. Ltd., Shenzhen (CN)

(72) Inventors: YANQING LUO, Shenzhen (CN); PEIYUN JIAN, Shenzhen (CN); NING LIU, Shenzhen (CN)

(73) Assignee: SuperD Co. Ltd

(21) Appl. No.: 15/137,886

(22) Filed: Apr. 25, 2016

(30) Foreign Application Priority Data
May 27, 2015 (CN) 2015-10278142.9

(51) Int. Cl. G06T 19/20; H04N 13/00; G06T 1/00; G06F 3/0482; G06F 3/0484

(52) U.S. Cl. CPC G06T 19/20; G06F 3/0482; G06F 3/04842; G06T 1/0007; H04N 13/0007; G06T 2200/24

(57) ABSTRACT

An image processing method and an image processing device are provided. The image processing method includes acquiring at least one to-be-processed image, the to-be-processed image is a 3D image having a first view image and a second view image, the first view image and the second view image have a horizontal parallax between them. The image processing method also includes receiving a user instruction and determining special-effect data to be inserted into the to-be-processed image, and based on special-effect attribute information, respectively combining the special-effect data with the first view image and the second view image of the to-be-processed image to obtain a 3D special-effect image. The image processing method also includes storing the 3D special-effect image. A corresponding horizontal parallax is formed between the special-effect data combined with the first view image and the special-effect data combined with the second view image. The special-effect attribute information includes position information of the special effect in the to-be-processed image and a number of frames of the 3D special-effect images to be generated.

### CROSS-REFERENCES TO RELATED APPLICATIONS

This application claims priority of Chinese Application No. CN201510278142.9, filed on May 27, 2015, the entire contents of which are hereby incorporated by reference.

### FIELD OF THE INVENTION

The present disclosure generally relates to the field of three-dimensional (3D) display technologies and, more particularly, relates to an image processing method and an image processing device.

### BACKGROUND

In three-dimensional (3D) display technologies, human-computer interaction is not limited to two-dimensional (2D) plane and has been extended to three-dimensional (3D) space. In pursuit of realism, interaction in three-dimensional space must be closely integrated with visual effects. As smart phones, tablet computers and other portable electronic devices are getting widely used, users may capture photos and videos using the built-in cameras and then may use application software to process the captured photos and videos, for example, for image enhancement, image modification, etc. However, such processing of the photos and videos may be still limited to 2D plane effects rather than dynamic 3D spatial effects. In pursuit of realistic 3D viewing experience, users are demanding dynamic 3D alteration of images data captured or stored in the portable electronic devices.

The disclosed image processing method and image processing device are directed to solve one or more problems set forth above and other problems in the art.

### BRIEF SUMMARY OF THE DISCLOSURE

One aspect of the present disclosure an image processing method. The image processing method includes acquiring at least one to-be-processed image, the to-be-processed image is a 3D image having a first view image and a second view image, the first view image and the second view image have a horizontal parallax between them. The image processing method also includes receiving a user instruction and determining special-effect data to be inserted into the to-be-processed image, and based on special-effect attribute information, respectively combining the special-effect data with the first view image and the second view image of the to-be-processed image to obtain a 3D special-effect image. The image processing method also includes storing the 3D special-effect image. A corresponding horizontal parallax is formed between the special-effect data combined with the first view image and the special-effect data combined with the second view image. The special-effect attribute information includes position information of the special effect in the to-be-processed image and a number of frames of the 3D special-effect images to be generated.

Another aspect of the present disclosure includes an image processing device. The image processing device includes an image acquisition unit configured to acquire at least one to-be-processed image, the to-be-processed image is a 3D image having a first view image and a second view image, and the first view image and the second view image have a horizontal parallax between them. The image processing device also includes a special effect selection unit configured to receive a user instruction and determine special-effect data to be inserted into the to-be-processed image, a combining unit, based on special-effect attribute information, configured to respectively combine the special-effect data with the first view image and the second view image to obtain a 3D special-effect image and a storage unit configure to store the 3D special-effect image. A corresponding horizontal parallax is formed between the special-effect data combined with the first view image and the special-effect data combined with the second view image. The special-effect attribute information includes position information of the special effect in the to-be-processed image and a number of frames of the 3D special-effect images to be generated.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a schematic view of dynamic effect of an exemplary image processing method consistent with disclosed embodiments;

FIG. 2 illustrates a flow chart of an exemplary image processing method consistent with disclosed embodiments;

FIG. 3 illustrates a first view image and a second view image of an exemplary to-be-processed image consistent with disclosed embodiments;

FIG. 4 illustrates a schematic view of implementing 3D special effect in a first view image and a second view image of an exemplary to-be-processed image in FIG. 3 consistent with disclosed embodiments;

FIG. 5 illustrates a schematic view of the effect of inserting a border to an exemplary to-be-processed image in FIG. 3 consistent with disclosed embodiments;

FIG. 6 illustrates a schematic diagram of an exemplary image processing device consistent with disclosed embodiments;

FIG. 7 illustrates an exemplary device consistent with disclosed embodiments; and

FIG. 8 illustrates a block diagram of an exemplary device consistent with disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. It is apparent that the described embodiments are some but not all of the embodiments of the present invention. Based on the disclosed embodiments, persons of ordinary skill in the art may derive other embodiments consistent with the present disclosure, all of which are within the scope of the present invention.

When no conflict exists, the exemplary features illustrated in various embodiments may be combined and/or rearranged. The specific details provided in the descriptions of various embodiments are intended to help understanding the present disclosure. However, the present disclosure may be implemented in other manners that are not described herein. Thus, the scope of the present disclosure is not limited to the disclosed embodiments. In various embodiments, the terms “first” and “second”, etc., are used to describe technical differentiations, and such terms may be replaced without departing from the scope of the present disclosure.

The present disclosure provides an image processing method for 3D image capturing or other image processing applications by, for example, built-in camera equipped mobile terminals, tablet computers, etc. The image processing method according to the present disclosure may also apply to, but is not limited to, 3D mobile phones, tablet computers, and other portable electronic devices that are integrated with light splitting devices such as gratings. The image processing method according to the present disclosure may also apply to 2D mobile phones.

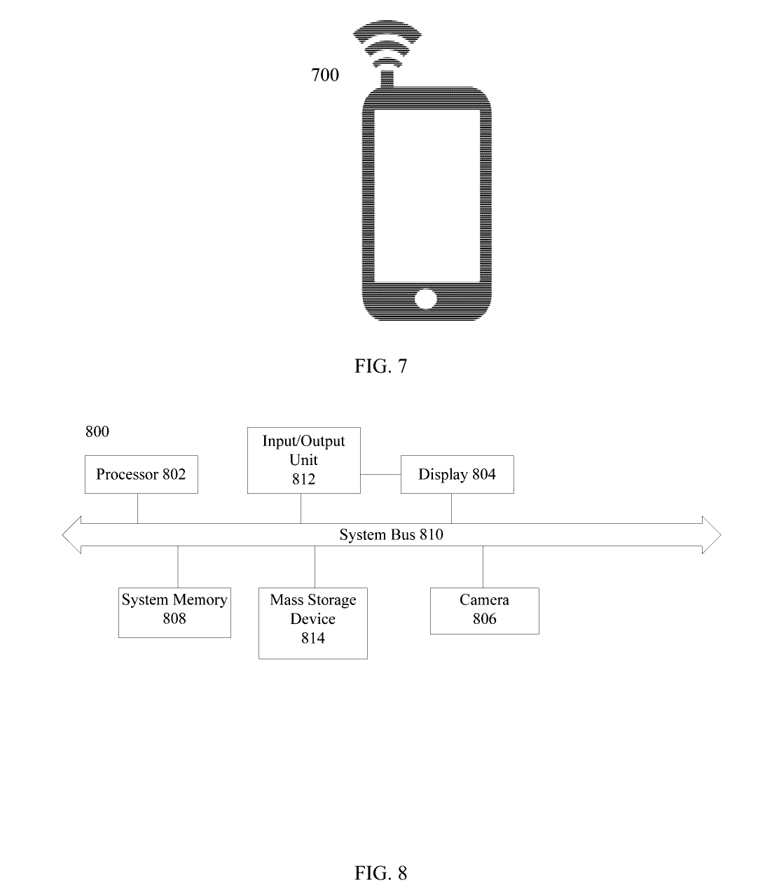

FIG. 7 illustrates an exemplary device consistent with disclosed embodiments. As shown in FIG. 7, the device 700 may be an electronic device capable of capturing 3D images, such as a mobile communication terminal, a tablet, and a digital camera, etc., or an electronic device capable of playing and/or generating 3D images such as a notebook, a TV, and a smartwatch, etc. In particular, a portable electronic device may be preferred, such as a 3D phone with a light splitting device (e.g. a grating) and a tablet. Although the device 700 is shown as a smartphone, any device with computing power may be used.

FIG. 8 illustrates a block diagram of an exemplary device consistent with disclosed embodiments. As shown in FIG. 8, the device 800 may include a processor 802, a display 804, a camera 806, a system memory 808, a system bus 810, an input/output unit 812, and a mass storage device 814. Other components may be added and certain devices may be removed without departing from the principles of the disclosed embodiments.

The processor 802 may include any appropriate type of central processing unit (CPU), graphic processing unit (GPU), general purpose microprocessor, digital signal processor (DSP) or microcontroller, and application specific integrated circuit (ASIC). The processor 802 may execute sequences of computer program instructions to perform various processes associated with the device 800.

The display 804 may be any appropriate type of display, such as plasma display panel (PDP) display, field emission display (FED), cathode ray tube (CRT) display, liquid crystal display (LCD), organic light emitting diode (OLED) display, light emitting diode (LED) display, or other types of displays.

The camera 806 may be an internal camera in the device 800 or may be an external camera connected to the device 800 over a network. The camera 806 may take images and/or videos to be processed by the processor 802.

The system memory 808 is just a general term that may include read-only memory (ROM), random access memory (RAM) and etc. The ROM may store necessary software for a system, such as system software. The RAM may store real-time data, such as images for displaying.

The system bus 810 may provide communication connections, such that the display device may be accessed remotely and/or communicate with other systems via various communication protocols, such as transmission control protocol/internet protocol (TCP/IP), hypertext transfer protocol (HTTP), etc.

The input/output unit 812 may be provided for users to input information into the display device or for the users to receive information from the display device. For example, the input/output unit 812 may include any appropriate input device, such as a remote control, a keyboard, a mouse, an electronic tablet, voice communication devices, or any other optical or wireless input devices.

Further, the mass storage device 814 may include any appropriate type of mass storage medium, such as a CD-ROM, a hard disk, an optical storage, a DVD drive, or other type of storage devices.

During an operating process, the processor 802 implementing various software units, may perform certain functions/steps to process and/or display images or videos to one or more users.

The present disclosure provides an image processing method for 3D image capturing or other image processing applications by, for example, built-in camera equipped mobile terminals, tablet computers, etc. The image processing method according to the present disclosure may also apply to, but is not limited to, 3D mobile phones, tablet computers, and other portable electronic devices that are integrated with light splitting devices such as gratings. The image processing method according to the present disclosure may also apply to 2D mobile phones.

The user may take a 3D image by his/her smartphone and want to beautify the 3D image through adding 3D dynamic effects, for example, floating feathers, snowflakes, bubbles or raindrops. Such a desire may be realized through a image processing method consistent with disclosed embodiments.

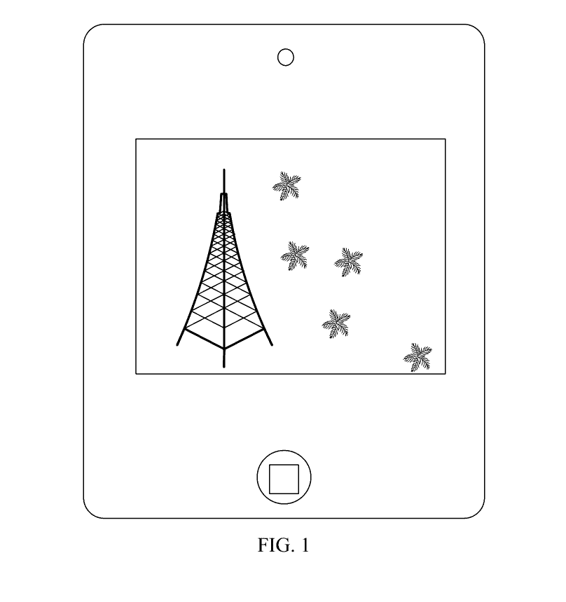

FIG. 1 illustrates a schematic view of dynamic effect of an exemplary image processing method consistent with disclosed embodiments. Referring to FIG. 1, after a user captures a 3D image by using a smartphone, the user may want to enhance the captured 3D image with 3D dynamic effects, such as floating feathers, snowflakes, bubbles, and rain drops, etc. The image processing method according to the present disclosure may be used by the user to achieve the desirable effects. As shown in FIG. 1, 3D special-effects of floating snowflakes are inserted into the 3D image captured by the user on a smartphone.

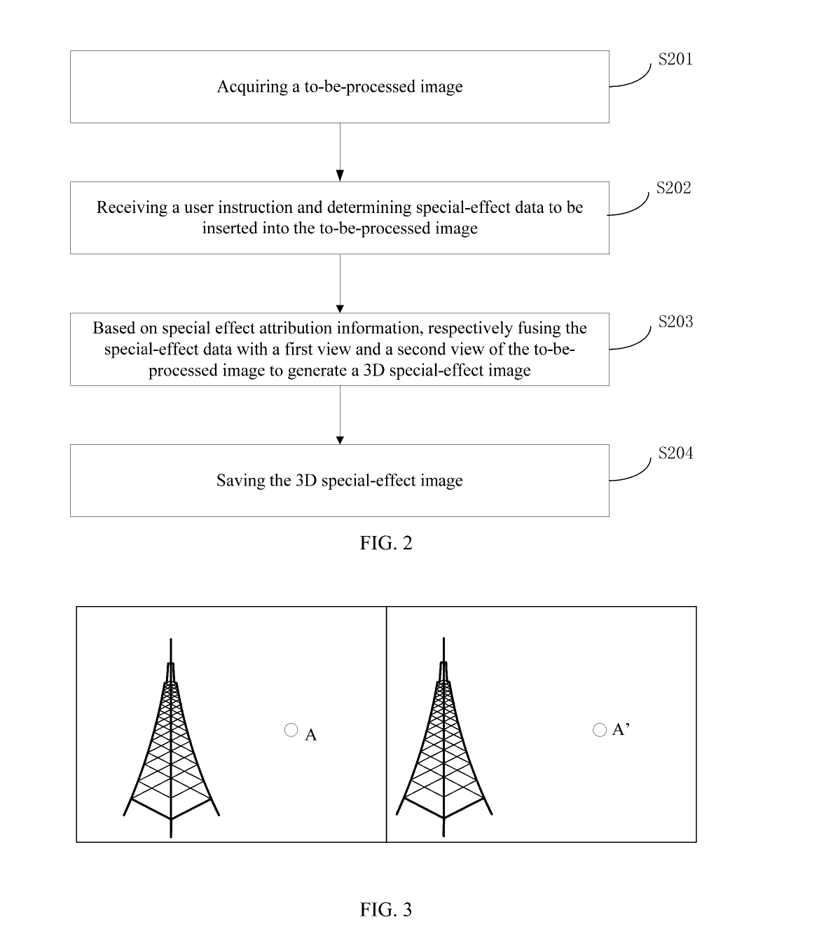

FIG. 2 illustrates a flow chart of an exemplary image processing method consistent with disclosed embodiments. Referring to FIG. 2, the image processing method may include the following steps.

Step S201: acquiring a to-be-processed image. The to-be-processed image may be a 3D image having a first view image and a second view image, the first view image and the second view image may have a parallax between them. The first view image may be a left view image of the 3D image (i.e., the to-be-processed image) and the second view image may be a right view image of the 3D image. Meanwhile, the first view image and the second view image of the 3D image may have a horizontal parallax. The to-be-processed image is also called as a 3D background image in the follow descriptions.

In another embodiment, the first view image may be a right view image of the 3D image (i.e., the to-be-processed image) and the second view image may be a left view image of the 3D image. The first view image and the second view image in the 3D image may have a horizontal parallax in the horizontal direction. In another embodiment, the first view image may be an upper view image of the 3D image and the second view image may be a lower view image of the 3D image. In another embodiment, the first view image may be a lower view image of the 3D image and the second view image may be an upper view image of the 3D image.

Further, the to-be-processed image may be acquired by the user using the camera, retrieved from system memory of an electronic device, downloaded or transmitted through a network, etc., which are only for illustrative purposes and are not intended to limit the scope of the present invention. In one embodiment, the to-be-processed images are acquired by the user using the camera.

Step S202: receiving a user instruction and determining special-effect data to be inserted to the to-be-processed image.

In this step, the user may select the desired special-effect data and may instruct certain image processing operations. Special-effect data, as used herein, may refer to data used for creating certain display or viewing effect in one or more images. An electronic device (for example, a smartphone) may obtain the special-effect data required for processing the 3D image based on the received user instruction.

In one embodiment, the disclosed image processing method may be implemented into an application program. The user may select the requested special-effect data from a dropdown list provided by the application program, from a search engine interface provided by the application program, or from a preconfigured template or model. For example, the user may enter text command in the search engine interface. According to the text command, the search engine may search the special-effect database to obtain the special-effect data searched by the user, which is then presented to the user to be selected by the user.

Step S203: based on special-effect attribute information, respectively combining the special-effect data with the first view image and the second view image of the to-be-processed image to obtain a 3D special-effect image or an image with the 3D special effect

In particular, the electronic device may combine the special-effect data and the to-be-processed image based on the special-effect attribute information. The 3D special-effect image may be a single view image including the special-effect data, content of the first view image and the second view image of the to-be-processed image. For one to-be-processed image, the electronic device may generate a plurality of 3D special-effect images based on the special-effect attribute information.

After combining the special-effect data with the first view image and the second view image, the corresponding effect may have a horizontal parallax. The special-effect attribute information may include position information of the special effect located in the to-be-processed image, variation information of the special-effect, and a number of frames of the 3D special-effect images required to be generated.

When the number of frames of the 3D special-effect images reaches a certain value, the desired dynamic effect may be observed when the plurality of 3D special-effect images are continuously displayed on a device capable of playing 3D images and/or videos, such as a 3D display device, etc. The value may be determined by a refresh rate on the 3D display device, i.e., a frame rate of the 3D display device.

The position information of the special effect in the to-be-processed image may include positions of the special-effect in the first view image and the second view image of the to-be-processed image, such as insertion positions (or initial positions) of the special-effect. The variation information of the special effect may include size variation information, trajectory variation information, color variation information, etc.

Further, before combining the special-effect data with the first view image and the second view image of the to-be-processed image, parallax information between the first view image and the second view image may be calculated. The parallax information between the first view image and the second view image may be retrieved from the smartphone. For example, the smartphone may capture the 3D image (i.e., the to-be-processed image), automatically compare the left view image (i.e., the first view image) and right view image (i.e., the second view image) of the 3D image to calculate the parallax information between the left view image and the right view image, and then store the parallax information in system memory.

In another embodiment, the smartphone may capture the 3D image and output the 3D image to a third party. The third party may compare the left view image (i.e., the first view image) and right view image (i.e., the second view image) of the 3D image to calculate the parallax information between the left view image and the right view image, and then return the parallax information to the smartphone.

The position information of the special effect in the 3D image (i.e., the to-be-processed image) may correspond to the parallax information between the first view image and the second view image of the 3D image. Based on the position information of the special effect in the 3D image (i.e., the positions of the special effect in the first view image and the second view image) and the parallax information between the first view image and the second view image of the 3D image, the special-effect may be combined with the first view image and the second view image of the 3D image at corresponding positions, respectively. Combining the special-effect with the first view image and the second view image of the 3D image may also change pixel data in the first view image and the second view image, respectively.

In certain other embodiments, the parallax information between the first view image and the second view image may not be calculated, the special-effect may be directly combined with a 3D background image.

The special-effect may be combined with the to-be-processed image through various approaches. For example, in one embodiment, when butterflies are used as the special-effect, pixels in a certain region of the first view image and the second view image of the 3D image may be replaced by pixel data corresponding to the butterfly, respectively. Thus, an image with the butterfly may be obtained. When being displayed on the 3D display device, the 3D special-effect of the butterfly may be observed.

It should be noted that, each 3D special-effect image may also include two view images: the first view image after being inserted with the special-effect data and the second view image after being inserted with the special-effect data. After the special-effect data are respectively combined with the first view image and the second view image of the to-be-processed image, the same special-effect in the two view images of the 3D special-effect image may have a parallax, which may be larger than the parallax between the first view image and the second view image of the to-be-processed image at corresponding positions.

The parallax of the same special effect between the two view images of the 3D special-effect image may be determined based on the position information of the same special effect in the 3D special-effect image, i.e., the positions of the same special effect in the first view image and the second view image of the 3D special-effect image.

For example, the position coordinate of the special-effect data in the first view image may be (100, 100). Both the row and column coordinates of the first view image are 100. The corresponding position coordinate in the second view image may be (102, 100). The insertion position of the special effect in each view image of different 3D special-effect images may be selected randomly, may be determined based on the user input, or may be determined by certain rules, such as a trajectory algorithm.

In the disclosed embodiments, the special-effect may be equivalent to the special-effect data. In certain other embodiment, the special-effect be different from the special-effect data.

Step S204: storing the 3D special-effect images. Specifically, after the 3D special-effect data is inserted into the first view and the second view of the to-be-processed image in steps S201-S203, the 3D special-effect images may be stored in, for example, an MP4 format or other displayable format. Then, the stored 3D special-effect images may be displayed or played back by the 3D display device, and the 3D dynamic effect may be observed on the 3D background image.

FIG. 3 illustrates a first view image and a second view image of an exemplary to-be-processed image consistent with disclosed embodiments. As shown in FIG. 3, the to-be-processed image may be a 3D image having a first view image and a second view image. The first view image may be a left view image of the 3D image and the second view image may be a right view image of the 3D image. The first view image and the second view image may have a horizontal parallax in a horizontal direction. The user may want to use the electronic device to enhance the 3D image through inserting 3D dynamic effect of floating snowflakes. The 3D image may be downloaded or captured by the user.

Based on the user instruction, the electronic device (e.g., a smartphone) may determine the to-be-processed image and desired dynamic effect to be inserted into the to-be-processed image. For example, the user may select snowflakes as the special effect through a dropdown list.

In one embodiment, the position information included in the special effect attribute information may be generated randomly or selected by the user through clicking a display screen of the electronic device. The number of 3D special-effect images may be determined by a model algorithm or may be input by the user. The special effect attribute information may also include variation information to control size variation, trajectory variation, and/or color variation.

It should be noted that, the first view image and the second view image in the to-be-processed image may have the horizontal parallax in the horizontal direction, parallax information between the first view image and the second view image may be acquired before combining the special effect with the to-be-processed image. In particular, the position information of the special effect in the to-be-processed image may correspond to the parallax information between the first view image and the second view image of the to-be-processed image, which may enable a fast and accurate combination of the special effect and the to-be-processed image.

Based on the position information of the special effect in the to-be-processed image and the parallax information between the first view image and the second view image of the to-be-processed image, the electronic device may combine the special effect with the first view image and the second view image at the corresponding positions, respectively. Combining the special effect with the to-be-processed image may also change pixel data in the first view image and the second view image of the to-be-processed image, respectively. For example, the pixel data at the corresponding position of each view image may be replaced by the special effect pixel data.

In certain embodiments, the parallax information between the first view image and the second view image of the to-be-processed image may not be calculated, and the special-effect may be directly combined with the 3D background image.

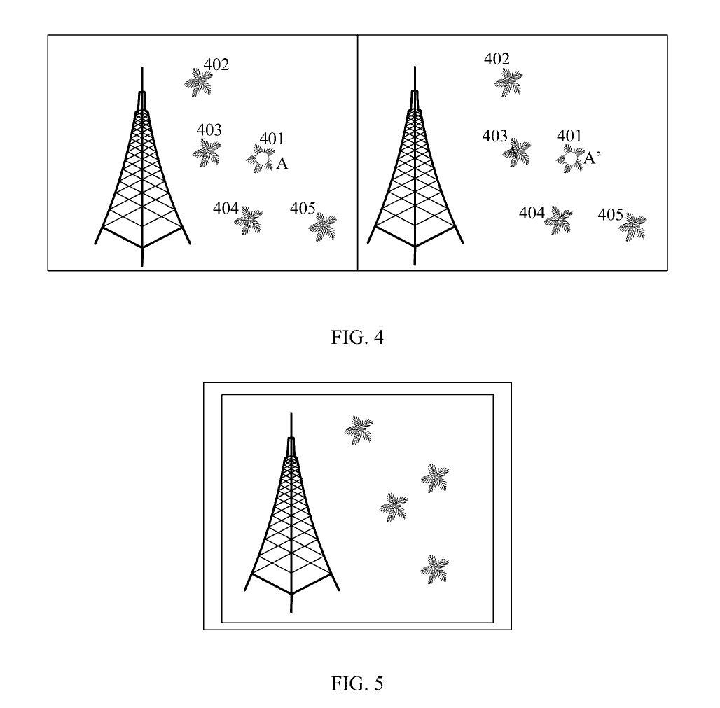

FIG. 4 illustrates a schematic view of implementing 3D special effect in a first view image and a second view image of an exemplary to-be-processed image in FIG. 3 consistent with disclosed embodiments. As shown in FIG. 4, the first view image may be a left view image of the to-be-processed image after inserting the 3D special effect, and the second view image may be a right view image of the to-be-processed image after inserting the 3D special effect.

After inserting the 3D special effect to the first view and the second view of the to-be-processed image, a 3D special-effect image may be obtained. A same special effect in the first view image and the second view image of the 3D special-effect image may have a parallax larger than the parallax between the first view image and the second view image of the to-be-processed image at corresponding positions.

For example, as shown in FIG. 4, a snowflake 401 may be combined with the first view image (the left view image) and the second view image (the right view image) at a position A (denoted by a circle) and a position A′ (denoted by a circle), respectively. Referring to FIG. 3, there is a corresponding position A (denoted by a circle) in the first view image (the left view image) and a corresponding position A′ (denoted by a circle) in the second view image (the right view image).

The parallax between the snowflake 401 in the first view image and the second view image of the 3D special-effect image may be larger than the parallax between the first view image and the second view image of the to-be-processed image at the corresponding positions. That is, the parallax between the position A and the position A′ in FIG. 4 may be larger than the parallax between the position A and the position A′ in FIG. 3.

Returning to FIG. 4, each special effect may be at a different position in each view image of the 3D special-effect image and, meanwhile, each special effect may have a position displacement between the two view images of each 3D special-effect image. That is, each special effect may have different positions in the first view image and the second view image of the 3D special-effect image, respectively.

For example, the snowflake 401, the snowflake 402, the snowflake 403, the snowflake 404 and the snowflake 405 may have different positions in the first view image (left view image) of the 3D special-effect image and, meanwhile, the snowflake 401, the snowflake 402, the snowflake 403, the snowflake 404 and the snowflake 405 may have different positions in the second view image (right view image) of the 3D special-effect image. Further, the position of the snowflake 401 in the first view image (left view image) may be shifted from the position of the snowflake 401 in the second view image (right view image). That is, the same snowflake 401 may have different positions in the first view image (left view image) and the second view image (right view image) of the 3D special-effect image, respectively. Similarly, the same snowflakes 402, 403, 404 and 405 may also have different positions in the first view image (left view image) and the second view image (right view image) of the 3D special-effect image, respectively.

Further, the position of the special effect snowflake in one 3D special-effect image may vary from the position of the corresponding snowflake in another 3D special-effect image. That is, the positions of the special effect snowflake in a plurality of 3D special-effect images may vary. Thus, when the plurality of 3D special-effect images are continuously displayed, a dynamic effect may be observed.

Especially when the plurality of 3D special-effect images, each containing two view images inserted with the special effect, are continuously displayed on the 3D display device (e.g., a smartphone), a 3D dynamic effect may be observed due to the horizontal parallax of the special effect, as FIG. 1 shows.

Returning to FIG. 4, to achieve the snowflake's 3D effect on a 3D display screen, in one embodiment, the snowflake may have a horizontal position displacement between the left view image and the right view image. The position displacement value may be randomly selected within a certain range. Moreover, the dynamic 3D effect may be implemented by using a template. The template may be used to generate the snowflakes. The template may include the snowflake position, the snowflake size, the snowflake parallax between two view images of each 3D special-effect image, and the snowflake trajectory, etc.

To interactively generate snowflakes, the user may first click an insertion position of the special effect, and the electronic device may insert snowflakes at the position clicked by the user and then spread out circularly or radially.

To randomly generate snowflakes, the user may not need to indicate any insertion position of the special effect, and the electronic device may randomly determine an initial insertion position and may insert snowflakes at the determined position and then spread out circularly or radially.

The interactive generation method and the random generation method may be similar except that the interactive method may generate the first special effect at the position clicked by the user. The special effect motion model may be a circular motion model. The position clicked by the user may be the center of a circle. The special effect at the radius r may be moved to the position at the radius r′. r′=kr. k is a scalar value and may not alter the direction of r.

The interactive generation method and the random generation method to combine the special effect with the to-be-processed image are for illustrative purpose, which are not intended to limit the scope of the present inventions. The details of the interactive generation method and the random generation method are not going to be explained here.

In the previous embodiments, 3D effect may be observed on the 3D display device. However, 3D effect may not be observed on a device which is only capable of displaying 2D images and/or videos, such as a 2D display device. On the 2D display device, only a plurality of continuously animated snowflake view images may be observed, like animated GIF images.

To observe 3D like dynamic effect on the 2D display device, before the step S203, i.e., before combining the special-effect data with the first view image and the second view image to obtain the 3D special-effect images, the electronic device may insert a border to the first view image or the second view image of the to-be-processed image. More specifically, the border may be inserted to one of the two view images of each to-be-processed image before the special effect is inserted.

FIG. 5 illustrates a schematic view of the effect of inserting a border to an exemplary to-be-processed image in FIG. 3 consistent with disclosed embodiments. As shown in FIG. 5, when a plurality of 2D view images with the border are played continuously, the user may experience 3D like dynamic effect. That is, when the left view image inserted with the special effect data and the right view image inserted with the special effect data are played back alternatingly and continuously, 3D like dynamic effect may also be achieved. Thus, the 2D and 3D compatible effect may be achieved.

After the 3D dynamic special effect has been inserted to the to-be-processed view image, the electronic device may store the 3D special-effect view images or the view images with the 3D special effect. Specifically, storing the view images with the 3D special effect may include the following.

Table 1 illustrates an exemplary method for storing 3D special-effect images consistent with disclosed embodiments.

TABLE 1

| | |
|---|---|
| First view image sequence | Second view image sequence |

As shown in Table 1, each 3D special-effect image may include a first view image and a second view image. The first view images of each 3D special-effect image may be stored sequentially, forming a first view image sequence. The second view images of each 3D special-effect image may be stored sequentially, forming a second view image sequence.

When the stored files are played back, the first view images and the second view images may be sequentially arranged or combined and then played.

Table 2 illustrates another exemplary method for storing 3D special-effect images consistent with disclosed embodiments.

TABLE 2
Combined (first view image + second view image) sequence

As shown in Table 2, each 3D special-effect image may include a first view image and a second view image. The first view image and the second view image in each 3D special-effect image may be combined or paired together to form a 3D special-effect image sequence corresponding to the frame number of the special effect attribute information. The 3D special-effect images included in the sequence may be sequentially stored in separated files. When the stored files are played back, the 3D special-effect images may be played sequentially.

In certain embodiments, the border may be inserted. Storing the 3D special-effect images with the border may include the following methods.

Table 3 illustrates another exemplary method for storing 3D special-effect images consistent with disclosed embodiments.

TABLE 3

| | | |
|---|---|---|
| Border sequence | First view image sequence | Second view image |
| | | sequence |

As shown in Table 3, each 3D special-effect image may include a first view image and a second view image. The first view images of each 3D special-effect image may be stored sequentially, forming a first view image sequence. The second view images of each 3D special-effect image may be stored sequentially, forming a second view image sequence. The border corresponding to each 3D special-effect image may be stored sequentially, forming a border sequence.

The first view image sequence, the second view image sequence and the border sequence may be stored in separated files. When the user plays the stored files on the 3D display device, the user may simply open the stored files and play sequentially.

When the user wants to transmit the stored files to the 2D display device that does not support 3D display, the user may only transmit the border sequence and one of the first view image sequence and the second view image sequence. Thus, not all the three sequences may be transmitted to the 2D display device, and data (i.e., files) required to be transmitted may be reduced.

Table 4 illustrates another exemplary method for storing 3D special-effect images consistent with disclosed embodiments.

TABLE 4

| | |
|---|---|
| Border sequence | Combined (first view image + second view image) |
| | sequence |

As shown in Table 4, each 3D special-effect image may include a first view image and a second view image. The first view image and the second view image in each 3D special-effect image may be combined or paired together to form a 3D special-effect image sequence corresponding to the frame number of the special effect attribute information. The border corresponding to each 3D special-effect image may be stored sequentially, forming a border sequence.

When the user wants to play the stored data on the 3D display device or to transmit the stored data to the 3D display device, the user may only need to play or transmit the 3D special-effect image sequence and may not transmit the border sequence. On the other hand, when the user wants to transmit the stored data to the 2D display device, the user may need to transmit the 3D special-effect image sequence and the border sequence, which may be sequentially combined before being played.

Further, the border may be combined with the first view image and the second view image of each 3D special-effect image to form a 3D special-effect image sequence with the border corresponding to the frame number of the special effect attribute information.

Table 5 illustrates another exemplary method for storing 3D special-effect images consistent with disclosed embodiments.

TABLE 5

Combined (border + first view image + second view image)
sequence

As shown in Table 5, each 3D special-effect image may include a first view image and a second view image. The first view image and the second view image in each 3D special-effect image as well as the border corresponding to each 3D special-effect image may be combined or paired sequentially, forming a 3D special-effect image sequence with the border corresponding to the frame number of the special effect attribute information.

Then the 3D special-effect image sequence with the border may be stored. When transmitting the stored data, the user may transmit the entire 3D special-effect image sequence with the border. When received by the 2D display device, the 3D special-effect image sequence with the border may be played directly and the 3D like dynamic effect may be observed.

Further, to meet requirements of data transmission, the to-be-processed image, dynamic special-effect attribute information, and the special effect may be stored in separate files. A sending electronic device may not process the images, but transmit the to-be-processed image, the special-effect attribute information, and the special-effect to a receiving electronic device.

Based on the dynamic special-effect attribute information, the receiving electronic device may process the to-be-processed image to obtain the images with the 3D dynamic effect, which may be identical as if the images with the 3D dynamic effect are generated by the sending electronic device. Because only the to-be-processed image, the dynamic special-effect attribute information, and the special-effect data are transmitted, the data required for transmission may be significantly reduced.

Table 6 illustrates an exemplary method for storing 3D special-effect images consistent with disclosed embodiments.

TABLE 6

| | |
|---|---|
| To-be-processed image | Dynamic special-effect attribute information |

As shown in Table 6, the to-be-processed image and the dynamic special-effect attribute information may be stored in separated files. The dynamic special-effect attribute information may include special-effect attribute information and special-effect data.

Table 7 illustrates another exemplary method for storing 3D special-effect images consistent with disclosed embodiments. The to-be-processed image may include a first view image and a second view image. A border may be inserted into the first view image or the second view image of the to-be-processed image.

TABLE 7

| | | |
|---|---|---|
| To-be-processed image | Dynamic special-effect | Border information |
| | attribute information | |

As shown in Table 7, the to-be-processed image, dynamic special-effect attribute information and border information may be stored in separated files. The dynamic special-effect attribute information may include special-effect attribute information and special-effect data.

Table 8 illustrates another exemplary method for storing 3D special-effect images consistent with disclosed embodiments.

TABLE 8

| | | |
|---|---|---|
| First view image | Second view image | Dynamic special-effect attribute |
| | | information |

As shown in Table 8, the to-be-processed image may include a first view image and a second view image. In each to-be-processed image, the first view image, the second view image and dynamic special-effect attribute information may be stored in separated files. The dynamic special-effect attribute information may include special-effect attribute information and special-effect data.

Table 9 illustrates another exemplary method for storing 3D special-effect images consistent with disclosed embodiments.

TABLE 9

| | | | |
|---|---|---|---|
| Border information | First | Second | Dynamic special-effect |
| | view | view image | attribute |
| | image | | information |

As shown in Table 9, each to-be-processed image may include a first view image and a second view image. A border may be inserted into the first view image or the second view image. The first view image, the second view image, dynamic special-effect attribute information and border information may be stored in separated files. The dynamic special-effect attribute information may include special-effect attribute information and special-effect data for the 3D special-effect.

Table 10 illustrates another exemplary method for storing 3D special-effect images consistent with disclosed embodiments.

TABLE 10

| | | |
|---|---|---|
| First view image | Second view image | Dynamic special-effect |
| sequence | sequence | attribute information |

As shown in Table 10, each 3D special-effect image may include a first view image and a second view image. The first view images of each 3D special-effect image may be stored sequentially, forming a first view image sequence. The second view images of each 3D special-effect image may be stored sequentially, forming a second view image sequence.

Further, dynamic special-effect attribute information may be also stored. The dynamic special-effect attribute information may include special-effect attribute information and special-effect data. The first view image sequence, the second view image sequence and the dynamic special-effect attribute information may be stored in separated files.

Table 11 illustrates another exemplary method for storing 3D special-effect images consistent with disclosed embodiments.

TABLE 11

| | | | |
|---|---|---|---|
| Border | First view image | Second view image | Dynamic |
| sequence | sequence | sequence | special-effect |
| | | | attribute information |

As shown in Table 11, each 3D special-effect image may include a first view image and a second view image. The first view images of each 3D special-effect image may be stored sequentially, forming a first view image sequence. The second view images of each 3D special-effect image may be stored sequentially, forming a second view image sequence. A border may be inserted into the first view image or the second view image of each 3D special-effect image. The border corresponding to each 3D special-effect image may be stored sequentially, forming a border sequence.

Further, dynamic special-effect attribute information may be also stored. The dynamic special-effect attribute information may include special-effect attribute information and special-effect data for the 3D special-effect. The first view image sequence, the second view image sequence, the border sequence and the dynamic special-effect attribute information may be stored in separated files.

The present disclosure provides the image processing method in various embodiments. The to-be-processed image may be acquired. Based on the user instructions, the special-effect data to be inserted into the to-be-processed image and the special-effect attribute information may be determined. Then the special-effect data may be combined with the to-be-processed image, and the 3D special-effect images may be obtained. When the 3D special effect images are played, desired 3D viewing experience may be observed to meet the user's requirements.

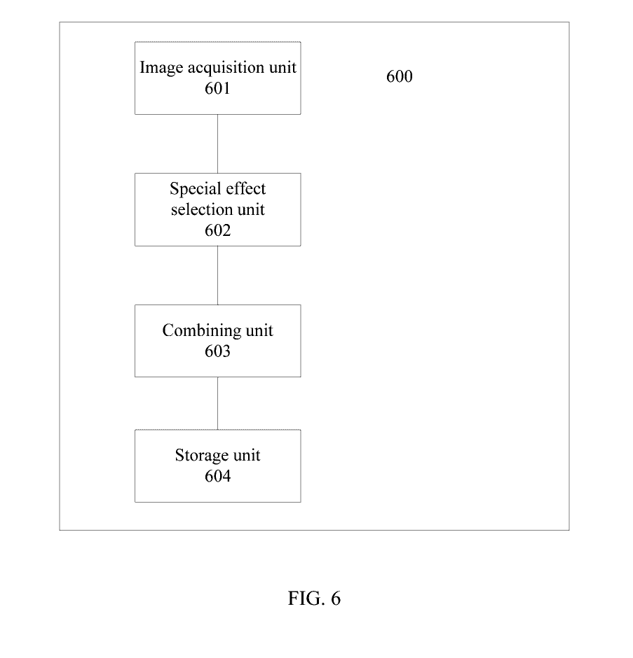

The present disclosure further provides an image processing device. FIG. 6 illustrates a structural schematic diagram of an exemplary image processing device consistent with disclosed embodiments. As shown in FIG. 6, the device 600 may include an image acquisition unit 601, a special effect selection unit 602, a combining unit 603 and a storage unit 604. All of the units may be implemented in hardware, software, or a combination of hardware and software. Software programs may be stored in system memory of a device, which may be called and executed by a processor to complete corresponding functions/steps.

The image acquisition unit 601 may be configured to acquire a to-be-processed image, which may be a 3D image having a first and the second view image. The first view image and the second view image of the to-be-processed image may have a parallax between them. The special effect selection unit 602 may be configured to receive user instructions and determine special-effect data for a 3D special-effect to be inserted into the to-be-processed image.

Based on special-effect attribute information, the combining unit 603 may be configured to combine the special-effect data with the first view image and the second view image respectively, thus a 3D special-effect image may be obtained. The 3D special-effect image may also include a first view image and a second view image.

In particular, after a same special effect corresponding to the data of the special effect is respectively combined with the first view image and the second view image of the to-be-processed image, the same special effect in the first view image and the second view image of the 3D special-effect image may have a parallax in a horizontal position. The special-effect attribute information may include position information of the special effect in the to-be-processed image and the number of 3D special-effect images to be generated.

The storage unit 604 may be configured to store the 3D special-effect images. The device 600 may be an electronic device implemented with the disclosed image processing methods. The details of the disclosed image processing device are not repeated here. It should be noted that, names of the software units are only for illustrative purposes, which are not intended to limit the scope of the present invention.

The image processing device consistent with disclosed embodiments may be able to acquire the to-be-processed image, determine the special-effect data to be inserted into the to-be-processed image and the special-effect attribute information based on the user instructions, combine the special-effect data with the to-be-processed image, and generate the 3D special-effect image. When the 3D special effect images are played, desired 3D viewing experience may be observed to meet the user's requirements.

Those of skill would further appreciate that the various illustrative units and algorithm steps disclosed in the embodiments may be implemented as electronic hardware, computer software, or combinations of both. To clearly illustrate this interchangeability of hardware and software, various illustrative units and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm disclosed in the embodiments may be embodied directly in hardware, in a software unit executed by a processor, or in a combination of the two. A software unit may reside in RAM, flash memory, ROM, EPROM (erasable programmable read-only memory), EEPROM (electrically erasable programmable read-only memory), registers, hard disk, a removable disk, a CD-ROM, or any other form of storage medium known in the art.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An image processing method, comprising:
acquiring at least one to-be-processed image, wherein the to-be-processed image is a 3D image having a first view image and a second view image, the first view image and the second view image have a horizontal parallax between them;
receiving a user instruction and determining special-effect data to be inserted into the to-be-processed image;
based on special-effect attribute information, respectively combining the special-effect data with the first view image and the second view image of the to-be-processed image to obtain a 3D special-effect image; and
storing the 3D special-effect image,
wherein a corresponding horizontal parallax is formed between the special-effect data combined with the first view image and the special-effect data combined with the second view image; and
the special-effect attribute information includes position information of the special effect in the to-be-processed image and a number of frames of the 3D special-effect images to be generated.

2. The image processing method according to claim 1, wherein:
each 3D special-effect image includes a first view image and a second view image.

3. The image processing method according to claim 1, wherein:
the corresponding horizontal parallax formed between the special-effect data combined with the first view image and the special-effect data combined with the second view image is equal to or larger than the horizontal parallax between the first view image and the second view image of the to-be-processed image.

4. The image processing method according to claim 1, wherein receiving the user instruction and determining the special-effect data to be inserted into the to-be-processed image further includes:
receiving the user instruction when the user selects from a dropdown list in a corresponding application program; and
determining the special-effect data based on the user instruction and the dropdown list selection.

5. The image processing method according to claim 1, wherein receiving the user instruction and determining the special-effect data to be inserted into the to-be-processed image further includes:
receiving the user instruction when the user enters a text command; and
searching the special-effect data in a special-effect database based on the text command.

6. The image processing method according to claim 1, wherein:
the special effect attribute information is determined by interpreting instructions entered by the user or by accessing preconfigured information stored in a template.

7. The image processing method according to claim 1, wherein based on the special-effect attribute information, respectively combining the special-effect data with the first view image and the second view image of the to-be-processed image to obtain the 3D special-effect image further includes:
acquiring parallax information between the first view image and the second view image of the to-be-processed image; and
based on the parallax information between the first view image and the second view image of the to-be-processed image, respectively combining the special-effect data with the first view image and the second view image of the to-be-processed image at corresponding positions,
wherein combining the special-effect data with the first view image and the second view image of the to-be-processed image includes replacing pixel data at the corresponding positions of first view image and the second view image of the to-be-processed image with pixel data corresponding to the special-effect data.

8. The image processing method according to claim 1, further including:
before respectively combining the special-effect data with the first view image and the second view image of the to-be-processed image to obtain the plurality of 3D special-effect images, adding a border to the first view image or the second view image of the to-be-processed image.

9. The image processing method according to claim 1, wherein storing the 3D special-effect image further includes:
sequentially storing the first view image in each 3D special-effect image in one file; and
sequentially storing the second view image in each 3D special-effect image in another file.

10. The image processing method according to claim 1, wherein storing the 3D special-effect image further includes:
sequentially combing the first view image and the second view image in each 3D special-effect image corresponding to the frame number of the special effect attribute information to form a 3D special-effect image sequence; and
sequentially storing the 3D special-effect images included in the 3D special-effect image sequence.

11. The image processing method according to claim 8, wherein storing the 3D special-effect image further includes:
sequentially storing the first view image in each 3D special-effect image;
sequentially storing the second view image in each 3D special-effect image; and
sequentially storing the border corresponding to each 3D special-effect image.

12. The image processing method according to claim 8, wherein storing the 3D special-effect image further includes:
sequentially combing the first view image and the second view image in each 3D special-effect image corresponding to the frame number of the special effect attribute information to form the 3D special-effect image sequence;
sequentially storing the 3D special-effect images included in the 3D special-effect image sequence; and
sequentially storing the border corresponding to each 3D special-effect images.

13. The image processing method according to claim 8, wherein storing the 3D special-effect image further includes:
sequentially combining the first view image, the second view image, and the border of the first view image or the second view image in each 3D special-effect images corresponding to the frame number of the special effect attribute information to form the 3D special-effect image sequence; and
sequentially storing the border corresponding to each 3D special-effect images.

14. The image processing method according to claim 1, wherein storing the 3D special-effect image further includes:
storing the to-be-processed image; and
storing dynamic special-effect attribute information,
wherein the dynamic special-effect attribute information includes the special-effect attribute information and the special-effect data.

15. The image processing method according to claim 8, wherein storing the 3D special-effect image further includes:
storing the to-be-processed image;
storing border information; and
storing the dynamic special-effect attribute information,
wherein the dynamic special-effect attribute information includes the special-effect attribute information and the special-effect data.

16. The image processing method according to claim 1, wherein storing the 3D special-effect image further includes:
storing the first view image of the to-be-processed image;
storing the second view image of the to-be-processed image; and
storing the dynamic special-effect attribute information,
wherein the dynamic special-effect attribute information includes the special-effect attribute information and the special-effect data.

17. The image processing method according to claim 8, wherein storing the 3D special-effect image further includes:
storing the first view image of the to-be-processed image;
storing the second view image of the to-be-processed image; and
storing the border information and the dynamic special-effect attribute information, wherein the dynamic special-effect attribute information includes the special-effect attribute information and the special-effect data.

18. The image processing method according to claim 1, wherein storing the 3D special-effect image further includes:
sequentially storing the first view image in each 3D special-effect image;
sequentially storing the second view image in each 3D special-effect image; and
storing the dynamic special-effect attribute information,
wherein the dynamic special-effect attribute information includes the special-effect attribute information and the special-effect data.

19. The image processing method according to claim 8, wherein storing the 3D special-effect image further includes:
sequentially storing the first view image in each 3D special-effect image;
sequentially storing the second view image in each 3D special-effect image;
storing the border information corresponding to each 3D special-effect image; and
storing the dynamic special-effect attribute information,
wherein the dynamic special-effect attribute information includes the special-effect attribute information and the special-effect data.

20. An image processing device, comprising:
an image acquisition unit configured to acquire at least one to-be-processed image, wherein the to-be-processed image is a 3D image having a first view image and a second view image, the first view image and the second view image have a horizontal parallax between them;
a special effect selection unit configured to receive a user instruction and determine special-effect data to be inserted into the to-be-processed image;
a combining unit, based on special-effect attribute information, configured to respectively combine the special-effect data with the first view image and the second view image to obtain a 3D special-effect image; and
a storage unit configure to store the 3D special-effect image,
wherein a corresponding horizontal parallax is formed between the special-effect data combined with the first view image and the special-effect data combined with the second view image; and
the special-effect attribute information includes position information of the special effect in the to-be-processed image and a number of frames of the 3D special-effect images to be generated.
